(19) United States
(12) Patent Application Publication
(10) Pub. No.: US 2019/0076853 A1
(43) Pub. Date: Mar. 14, 2019

(54) ELECTROSTATIC AIR CLEANER

(71) Applicant: Jiangmen Pro-in Technology Manufacturing Co., Ltd, Jiangmen City (CN)

(72) Inventor: Xinmin Ma, Taishan city (CN)

(21) Appl. No.: 16/120,593

(22) Filed: Sep. 4, 2018

(30) Foreign Application Priority Data
Sep. 8, 2017 (CN) 201710806482.3

(51) Int. Cl. B03C 3/36; B03C 3/41; B03C 3/47; B03C 3/155

(52) U.S. Cl. CPC B03C 3/366; B03C 3/41; B03C 2201/04; B03C 3/155; B03C 3/47

(57) ABSTRACT

The present invention discloses an electrostatic air cleaner, comprising an upper filter screen, an electrode a, a tungsten wire, a spring, a main body, an ionization generator, a lower filter screen, an electrode b and an electrode c. The main body is a hollow structure, and the upper end of the main body is buckled with the upper filer screen and the lower end of the main body is buckled with a lower filter screen. A tungsten wire fixed at the upper end of the main body is provided at the inner side of the upper filter screen and the both ends of the tungsten wire are respectively connected with a spring, and the tungsten wire is tensioned by the spring to prevent sagging or deformation, wherein one spring is hitched on the electrode a, the electrode a is fixed on the upper end of the main body, and the main body is provided with an ionization generator. The ionization generator is disposed on the lower side of the tungsten wire and connected to the tungsten wire; the lower end of the main body is further provided with an electrode b and an electrode c arranged side by side. The electrode b and electrode c are connected to the ionization generator and disposed at the upper side of the lower filter screen. Its structure is simple and scientific, convenient to use, without consumables and replacing parts, with low cost and energy saving, good cleaning effect. Therefore, the invention can meet the market demands and it is worthy of promotion in the markets.

### FIELD OF THE INVENTION

The present invention relates to an environmental cleaning technology, in particular to an electrostatic air cleaner for dust adsorption and bacteria killing of an air cleaner.

### BACKGROUND

At present, the air cleaning devices available in the markets generally adopt a multi-layer filter screen or an activated carbon filter screen, which have no sterilization functions and are prone to failure; moreover, it requires periodic replacement, with high costs.

In addition, bacteria are prone to generate on the cleaning devices after a period of time, causing secondary pollution, so it cannot clean the air in a continuous and effective way.

The existing electrostatic air cleaners in the markets adopt straight-blade design, with large volume. Its adsorption efficiency per unit area when the airflow passes through the electrostatic device directly is low.

### SUMMARY

The object of the present invention is to provide an electrostatic air cleaner to overcome the shortcomings of the prior art. Its structure is simple and scientific, convenient to use, without consumables and replacing parts, with low cost and energy saving, good cleaning effect. Therefore, the present invention can meet the market demands and it is worthy of promotion in the markets.

In order to achieve the above object, the present invention adopts the following technical solutions.

An electrostatic air cleaner, comprising an upper filter screen, an electrode a, a tungsten wire, a spring, a main body, an ionization generator, a lower filter screen, an electrode b and an electrode c, the main body is a hollow structure, and the upper end of the main body is buckled with the upper filer screen and the lower end of the main body is buckled with a lower filter screen; a tungsten wire fixed at the upper end of the main body is provided at the inner side of the upper filter screen and the both ends of the tungsten wire are respectively connected with a spring, and the tungsten wire is tensioned by the spring to prevent sagging or deformation, wherein one spring is hitched on the electrode a, the electrode a is fixed on the upper end of the main body, and the main body is provided with an ionization generator, the ionization generator is disposed on the lower side of the tungsten wire and connected to the tungsten wire; the lower end of the main body is further provided with an electrode b and an electrode c arranged side by side, the electrode b and electrode c are connected to the ionization generator and disposed at the upper side of the lower filter screen.

The electrode c is switched on positive electricity and the electrode b is switched on negative electricity, the electrode a is switched on the tungsten wire, the electrode c transmits positive electricity and the electrode b transmits negative electricity.

The ionization generator is composed of a plurality of sets of “five-short and one-long” W-type electrostatic sheets, and the both ends of the electrostatic sheet are respectively clamped into a slot matching with the electrostatic sheet that is disposed at the inner side of the main body.

The long electrostatic sheet is negative and the short electrostatic sheet is disposed at positive and negative intervals in each group of the W-type electrostatic sheets, by positively charging the electrode a, an electrostatic field is generated with a negatively charged electrostatic sheet.

The lower end of the W-type electrostatic sheet of the ionization generator is connected in series to three electrodes b arranged side by side respectively.

The W-type electrostatic sheets are arranged closely and neatly according to a fixed size at a mean distance of 6 mm, and the currents of the positive and negative, high and low voltages are transmitted to the ionization generator composed of the W-type high-voltage electrostatic sheet and the tungsten wire respectively, to generate ionization and high-voltage static electricity.

The electrostatic air cleaner in the present invention can achieve the following beneficial effect. Its structure is simple and scientific, convenient to use, without consumables and replacing parts, with low cost and energy saving, good cleaning effect. Therefore, it can meet the market demands and it is worthy of promotion in the markets.

It has solved the consumables for air cleaner, and the consumables need not be replaced after using the electrostatic device. Bacteria are killed by high-voltage discharge principle to prevent secondary contamination.

Dust is electrified and adsorbed on the ionization generator by high-voltage static electricity, to achieve the purpose of dust removal, air cleaning and sterilization.

Firstly, by using W-type high-voltage electrostatic sheet continuously, a more compact adsorption plane with large contact area is formed in the same volume. When the airflow passes through the air passage formed by the W-type high-voltage electrostatic sheet, resistance will be generated to improve the efficiency.

Secondly, the W-type high-voltage electrostatic sheet has high strength. It is not easy to be deformed during cleaning and it has an average discharge interval. Its electric discharge is more stable with higher voltage, to enhance the adsorption efficiency.

Thirdly, due to the action of exhaust fan, all passing air will strike the electrostatic sheets when the airflow passes through the W-type high-voltage electrostatic sheets and the dust particles and bacteria in the air will be in adequately contact with the electrostatic sheets and adsorbed by the electrostatic sheets.

### BRIEF DESCRIPTION OF THE DRAWINGS

FIG. 1 is schematic view of an electrostatic air cleaner of the present invention;

FIG. 2 is a cross-sectional view of an electrostatic air cleaner of the present invention;

FIG. 3 is an exploded view of an electrostatic air cleaner of the present invention.

### DETAILED DESCRIPTION

The preferred embodiment of the invention is further described in detail below.

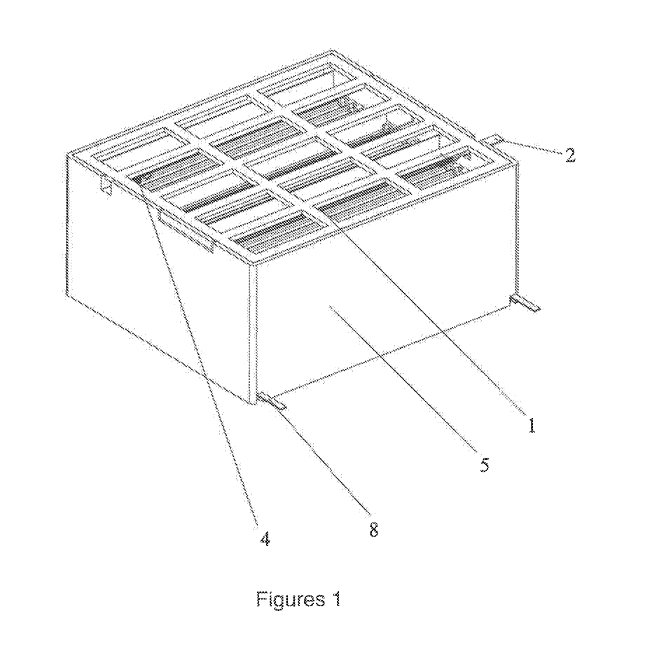

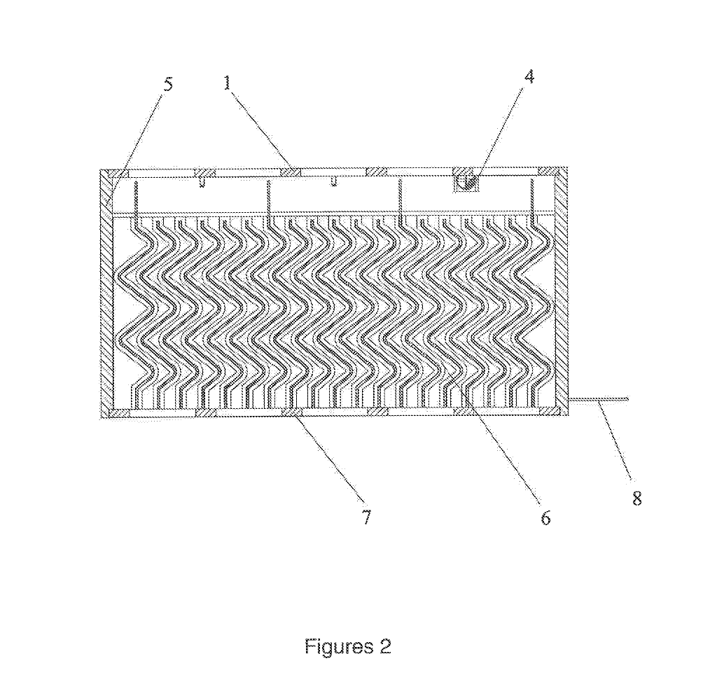

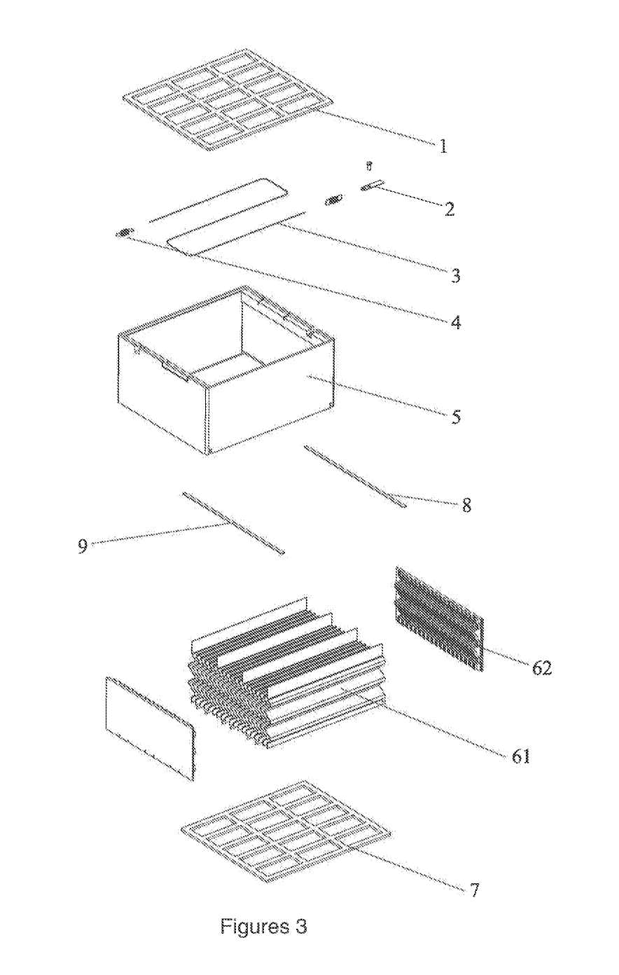

Referring to FIGS. 1-3, in the present invention, the electrostatic air cleaner, comprising an upper filter screen 1, an electrode a2, a tungsten wire 3, a spring 4, a main body 5, an ionization generator 6, a lower filter screen 7, an electrode b8 and an electrode c9, the main body 5 is a hollow structure, and the upper end of the main body 5 is buckled with the upper filer screen 1 and the lower end of the main body 5 is buckled with a lower filter screen 7; the upper filter screen 1 and the lower filter screen 7 filter the large dusts; a tungsten wire 3 fixed at the upper end of the main body 5 is provided at the inner side of the upper filter screen 1 and the both ends of the tungsten wire 3 are respectively connected with a spring 4, and the tungsten wire is tensioned by the spring to prevent sagging or deformation, wherein one spring 4 is hitched on the electrode a2, the electrode a2 is fixed on the upper end of the main body 5, and the main body 5 is provided with an ionization generator 6, the ionization generator 6 is disposed on the lower side of the tungsten wire 3 and connected to the tungsten wire 3; the lower end of the main body 5 is further provided with an electrode b8 and an electrode c9 arranged side by side, the electrode b8 and electrode c9 are connected to the ionization generator 6 and disposed at the upper side of the lower filter screen 7.

The electrode c is switched on positive electricity and the electrode b is switched on negative electricity, the electrode a is switched on the tungsten wire, the electrode c transmits positive electricity and the electrode b transmits negative electricity.

The ionization generator 6 is composed of a plurality of sets of “five-short and one-long” W-type electrostatic sheets 61, and the both ends of the electrostatic sheet 61 are respectively clamped into a slot 62 matching with the W-type electrostatic sheet 61 that is disposed at the inner side of the main body 5.

The long electrostatic sheet is negative and the short electrostatic sheet is disposed at positive and negative intervals in each group of the W-type electrostatic sheets, by positively charging the electrode a, an electrostatic field is generated with a negatively charged electrostatic sheet.

The lower ends of the W-type electrostatic sheet 61 of the ionization generator 6 are equally connected in series to three electrodes b8 arranged side by side respectively.

The W-type electrostatic sheets 61 are arranged closely and neatly according to a fixed size at a mean distance of 6 mm, and the currents of the positive and negative, high and low voltages are transmitted to the ionization generator 6 composed of the W-type high-voltage electrostatic sheet and the tungsten wire 3 respectively, to generate ionization and high-voltage static electricity. When ionization occurs and high-voltage static electricity generates an electrostatic field, the air is ionized, and the dust and gas are combined with negative ions and negatively charged. When electrons go to the positive electrode, dust and gas with negative ions are adsorbed on the positive electrode. After air ionization, the number of ions moving between electrodes is greatly increased due to chain reaction. The current between electrodes increases sharply, the air becomes a conductor. The high-strength voltage captures the particles carrying bacteria and instantly breaks down the cell wall composed of protein to achieve sterilization. The high voltage static electricity also generates negative ions, which can enhance the immunity and improve the self-healing of human body, promote cell regeneration and produce a good therapeutic effect on asthma and trachitis, etc.

Using the principle of anodic corona discharge, the dust in the air is charged with a positive charge, and then the discharged ions are trapped on the dust collecting device by the action of Coulomb force to achieve the function of dust removal and air cleaning.

Case A: In a space of 20 cubic meters, four people are smoking. By starting the matching air cleaner, the smell of smoke will disappear within a short period of time and the air quality is obviously improved.

Case B: In a space with high flue density, when the device is started, the air in the device is ionized to become a conductor, to generate a high voltage and capture particles with bacteria, instantly break through the cell wall composed of protein and kill the bacteria, thus the bacteria in the space are obviously reduced in a short period of time.

The foregoing descriptions further illustrate the present invention in conjunction with the specific preferred embodiments, so that those skilled in the art can understand and apply the invention. However, the present invention is not limited to the description. It will be apparent to those skilled in the art that simple deductions or substitutions can be made without departing from the inventive concept. Therefore, any simple improvement made to the present invention by those skilled in the art according to the disclosure herein should fall within the scope of protection of the present invention.

What is claimed is:

1. An electrostatic air cleaner, comprising an upper filter screen, an electrode a, a tungsten wire, a spring, a main body, an ionization generator, a lower filter screen, an electrode b and an electrode c, the main body is a hollow structure, and the upper end of the main body is buckled with the upper filer screen and the lower end of the main body is buckled with a lower filter screen; a tungsten wire fixed at the upper end of the main body is provided at the inner side of the upper filter screen and the both ends of the tungsten wire are respectively connected with a spring, and the tungsten wire is tensioned by the spring to prevent sagging or deformation, wherein one spring is hitched on the electrode a, the electrode a is fixed on the upper end of the main body, and the main body is provided with an ionization generator, the ionization generator is disposed on the lower side of the tungsten wire and connected to the tungsten wire; the lower end of the main body is further provided with an electrode b and an electrode c arranged side by side, the electrode b and electrode c are connected to the ionization generator and disposed at the upper side of the lower filter screen.

2. The electrostatic air cleaner according to claim 1, wherein the ionization generator is composed of a plurality of sets of “five-short and one-long” W-type electrostatic sheets, and the both ends of the electrostatic sheet are respectively clamped into a slot matching with the electrostatic sheet that is disposed at the inner side of the main body.

3. The electrostatic air cleaner according to claim 2, wherein the electrode c is switched on positive electricity and the electrode b is switched on negative electricity, the electrode a is switched on the tungsten wire, the electrode c transmits positive electricity and the electrode b transmits negative electricity.

4. The electrostatic air cleaner according to claim 3, wherein the long electrostatic sheet is negative and the short electrostatic sheet is disposed at positive and negative intervals in each group of the W-type electrostatic sheets, by positively charging the electrode a, an electrostatic field is generated with a negatively charged electrostatic sheet.

5. The electrostatic air cleaner according to claim 4, wherein the lower ends of the W-type electrostatic sheet of the ionization generator is connected in series to three electrodes b arranged side by side respectively.

6. The electrostatic air cleaner according to claim 5, wherein the W-type electrostatic sheets are arranged closely and neatly according to a fixed size at a mean distance of 6 mm, and the currents of the positive and negative, high and low voltages are transmitted to the ionization generator composed of the W-type high-voltage electrostatic sheet and the tungsten wire respectively, to generate ionization and high-voltage static electricity.
